(19) United States
(12) Patent Application Publication
(10) Pub. No.: US 2021/0229216 A1
(43) Pub. Date: Jul. 29, 2021

(54) SYSTEMS AND METHODS FOR IMPROVING ACCURACY IN LARGE AREA LASER PROCESSING USING POSITION FEEDFORWARD COMPENSATION

(71) Applicant: Novanta Corporation, Bedford, MA (US)

(72) Inventors: Mark Lucas, Acton, MA (US); Seetharam Sivam, Concord, MA (US)

(21) Appl. No.: 17/155,854

(22) Filed: Jan. 22, 2021

Related U.S. Application Data
(60) Provisional application No. 62/965,491, filed on Jan. 24, 2020.

(51) Int. Cl. B23K 26/082; B23K 26/03; B23K 26/06; B23K 26/08

(52) U.S. Cl. CPC B23K 26/082; B23K 26/083; B23K 26/0643; B23K 26/0344

(57) ABSTRACT

A laser processing system providing on-the-fly laser processing of a workpiece is disclosed. The laser processing system includes a positioning system configured to support the workpiece, a positioning system controller configured to control movement of the workpiece on the positioning system, a scanner system configured to scan a laser beam over the workpiece, and a scanner controller configured to operate the scanner system and the positioning system controller, the scanner controller receiving vector input data for use in feed-forward position compensation.

### PRIORITY

The present application claims priority to U.S. Provisional Patent Application No. 62/965,491 filed Jan. 24, 2020, the disclosure of which is hereby incorporated by reference in its entirety.

### BACKGROUND

The present invention generally relates to laser scanning systems, and relates in particular to large-area on-the-fly laser marking and cutting systems.

Laser scanning systems are often used for marking or cutting materials while they are in motion. Such a process is typically referred to in the industry as on-the-fly. These systems generally employ position measurement systems such as rotary or linear encoders as feedback for the control of the motion of the workpiece positioning system. In two-axis systems, the workpiece positioning system is often an XY stage, although in some systems, the workpiece is positioned in a single axis, and the scan head is positioned over the workpiece in an orthogonal axis. As used herein, the term positioning system generally refers to these system configurations and their equivalents. A laser galvanometer controller can use the encoder information of the positioning system to offset the galvanometer positions in such a way as to cause the steered laser beam to follow the motion of the workpiece.

High accuracy laser micromachining over large areas has given rise to system designs that use external motion systems to move a workpiece underneath the fixed scan area of a laser process scan head. The external motion systems may be single-axis, often used in web-based converting tools, or two-axis gantry (or XY) stage based systems used for instance, in display processing such as organic light emitting diode (OLED) cutting, indium tin oxide (ITO) scribing, via-hole drilling and the like. In such two-axis systems, laser beam positioning accuracy has become much more stringent because of the requirement to align the laser processing step to artwork on the workpiece that is produced using high precision semiconductor processing techniques. Accurate and repeatable positioning of the laser beam to +/−5 μm over a process area of +/−500 mm (effectively a precision of 10 PPM) is often needed for such systems.

Certain laser positioning systems employ combined laser head positioning and workpiece positioning. For example, U.S. Pat. No. 5,751,585 discloses systems that uses X and Y positioning systems to move a scan head in one dimension, and move the material in the other dimension for a combined system layout that is disclosed to be compact. Motion between the positioning system and the galvanometers is coordinated through path panning analyses.

U.S. Patent Application Publication No. 2018/0339364 discloses a system in which the laser scanner controller enslaves a separate XY stage controller and directs the XY stage synchronously with the laser steering galvanometers. The system employs a cross-communication domain interface to transfer information between the scanner controller and the stage controller, including position commands that the stage controller needs to follow and clock information that is used to synchronize the scanner controller and the stage controller.

U.S. Patent Application Publication No. 2018/0056443 discloses a laser machining device with a laser scanner and a movable stage that is controlled by a stage controller. The laser scanner is controlled by a scanner controller that synchronizes movements of the stage as controlled by the stage controller. This disclosure also includes a bridging device that synchronizes and transfers real time data between controllers of two subsystems such as the scanner controller and the stage controller. The disclosure of this reference notes, however, that the accuracy of systems that employ multiple scanners is limited by the fact that the path command of the scanner is based on a feedback reading, which is necessarily delayed relative to the command and is noisier and may be prone to error.

Laser galvanometer-based steering systems generally use closed-loop servo motors with position feedback provided by integrated sensors on the galvanometer motors. Such servo systems have a finite tracking delay between the commanded position and the actual mirror position. This tracking delay causes a positional error of the laser beam while following the material positioning system. This is because the positioning encoder system that is inducing galvanometer positional command changes is measuring the instantaneous position of the positioning system. The actual location of the positioning system, however, will have moved to a new relative location during the galvanometer tracking delay interval.

With large-area micro-machining systems, the magnitude of such errors exceeds the error budget by more than an order of magnitude. For example, a typical galvanometer servo system has a tracking delay of 250 μsec, and with a workpiece positioning system moving at 500 mm/sec, the resulting positional error will be 0.00025(sec)*500 (mm/sec)=0.125 (mm). This would result in completely unacceptable laser process control for such systems.

The article Laser Scanner-Stage Synchronization Method for High-Speed and Wide-Area Fabrication, Journal of Laser Micro/Nanoengineering (JLMN), vol. 7, No. 2, 2012, discloses an on-the-fly method to synchronize a laser galvanometer scanner and linear stage for wide-area fabrication. The article discloses a large-area processing system that uses XY stage position encoder data to cause the laser scanning system to track the movement of material positioning system (XY stage) to implement 2D laser processing on-the-fly. The system of this reference is disclosed to provide real-time signal transfer between the linear stage and the galvanometer scanner.

There remains a need however, for a more efficient and more economical on-the-fly laser marking system that provides improved laser marking accuracy at higher speeds and accuracy.

### SUMMARY

In accordance with an aspect, the invention provides a laser processing system providing on-the-fly laser processing of a workpiece is disclosed. The laser processing system includes a positioning system configured to support the workpiece, a positioning system controller configured to control movement of the workpiece on the positioning system, a scanner system configured to scan a laser beam over the workpiece, and a scanner controller configured to operate the scanner system and the positioning system controller, the scanner controller receiving vector input data for use in feed-forward position compensation.

In accordance with another aspect, the invention provides a laser processing system providing on-the-fly laser processing of a workpiece. The laser processing system includes a positioning system configured to support the workpiece, a positioning system controller configured to control movement of the workpiece on the positioning system, a scanner system configured to scan a laser beam over the workpiece, and a scanner controller configured to operate the scanner system and the positioning system controller, the scanner controller determining an anticipated vector of the positioning system for use in feed-forward position compensation.

In accordance with a further aspect, the invention provides a method of providing on-the-fly laser processing of a workpiece, said method includes providing a positioning system configured to support the workpiece, providing a positioning system controller configured to control movement of the workpiece on the positioning system, providing a scanner system configured to scan a laser beam over the workpiece, providing a scanner controller configured to operate the scanner system and the positioning system controller, operating the positioning system controller responsive to vector input data, and operating the scanner system at a positioning system delay compensated high data rate.

### BRIEF DESCRIPTION OF THE DRAWINGS

The application may be further understood with reference to the accompanying drawings in which:

FIG. 1 shows an illustrative diagrammatic functional view of a scanner and control system in accordance with an aspect of the present invention;

FIG. 2 shows an illustrative diagrammatic component view of the system of FIG. 1; and

FIG. 3 shows an illustrative diagrammatic coordinate representation of relative positions of a scan head and workpiece in a system of FIG. 1.

The drawings are shown for illustrative purposes only.

### DETAILED DESCRIPTION

Applicants have discovered that galvanometer tracking delay induced positioning error can be substantially reduced or eliminated by taking advantage of the high bandwidth, high speed and acceleration capabilities of the galvanometers relative to the low bandwidth slow moving and high-inertia workpiece positioning system. Further, it has been discovered that calculation of the velocity and acceleration of the workpiece positioning system from the position encoder data used for position tracking is possible by integrating the positional change over a finite period of time.

The prediction of the future location of the positioning system using this velocity information assumes that the motion of the positioning system will be approximately straight-line over the time interval of the galvanometer tracking delay. This assumption is considered valid because the typical positional update rate for changing the positioning system position is 5 KHz or less, or 200 μsec per each command update. Over the galvanometer tracking delay interval therefore, the positioning system will be traveling in a near straight line because the commanded position of the system is updated only once in the interval. In addition, the positioning system servo controller has its own tracking delay that results in a delayed reaction to new commands that further enhances this assumption.

The predicted position of the positioning system relative to the current measured position is added to the galvanometer command stream. The higher bandwidth of the galvanometer servo system enables the positioning of the galvanometer mirrors to be on the predicted path of the positioning system regardless of changes in velocity and position of the positioning system. The process involves position feed-forward motion control, and reduces tracking delay of a servo system during a constant velocity mode of operation. The tracking delay may be defined as the delay between the commanded position and the actual position of actuator controlled by the servo system. In systems of embodiments of the present invention however, position feed-forward is used to adjust galvanometer trajectory such that the system follows the predicted path of a measured external motion system.

Laser galvanometer servo tracking delays cause scanning positional errors during workpiece-following in workpiece motion-tracking applications. This is the result of the workpiece moving from the time of the measurement of the position of the workpiece to the time when the mirrors are deflected based on the measurement. A substantial improvement of laser scanning system accuracy in accordance with various aspects of the invention uses position feed-forward compensation based on estimated velocity and acceleration of the workpiece positioning system. Calculation of a predictive position adjustment for the laser galvanometers proportional to the servo tracking delay of the galvanometers is possible using the position encoder data of the workpiece positioning system to derive velocity and acceleration of the system. The predictive adjustment of the command data causes the beam to be steered to the actual position of the moving workpiece thus improving overall laser positioning accuracy.

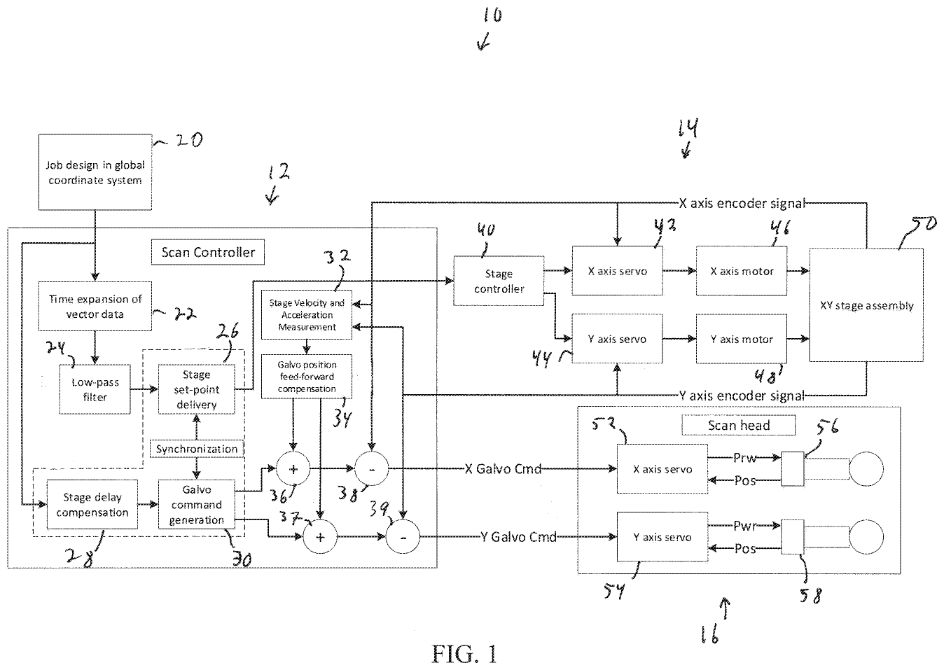

In accordance with an embodiment, the invention involves using position feed-forward in a mark-on-the-fly laser scanning system. FIG. 1, for example, shows at 10 a functional view of the logical flow of such a position feed-forward control system. In particular, FIG. 1 shows a control system 10 that includes a scan controller 12 that drives both a positioning system, in this case an XY stage 14 and a scan head 16. The overall laser processing data is represented as vector data in a global coordinate system 20 that is aligned with the positioning and galvanometer coordinate systems through appropriate coordinate transformations, and is provided to the scan controller 12. The global job coordinate system origin and laser galvanometer origin coincide with each other, while the positioning system origin and positional coordinates of the positioning system are aligned using linear transformations at run-time.

The job data is provided to two paths. In one path, the vector data is time-domain expanded 22, low-pass filtered 24, and queued for delivery to the positioning system at a reduced data rate 26. In the second path, the original job data execution is delayed 28 by the duration of the empirically derived positioning system tracking delay to allow the positioning system to start moving. The job vector data is time-domain expanded at a high data rate, typically 100 KHz, for delivery to the galvanometer servos 30. Upon job start, the low-pass filtered job data is delivered to the positioning system via the positioning system controller 40 at a reduced update rate that may or may not be synchronous with the galvanometer update rate. After the positioning system tracking delay, the galvanometer data is delivered to galvanometer servos 50 at the high data rate.

The positioning system encoder data is sampled at the same rate as the galvanometer command data delivery rate and is integrated over several sample intervals to calculate the average velocity and acceleration of the positioning system 32. A position offset is calculated for the galvanometers that is proportional to the galvanometer tracking delay and the currently calculated positioning system velocity and acceleration 34. This offset is added to the galvanometer command data 36. The offset is the predictive positional bias that causes the laser to be steered to where the workpiece will be after the tracking delay. In a subsequent step, the adjusted galvanometer command data is further adjusted by subtracting the current positioning system position as measured by the positioning system encoders 38. The latter computation effectively removes the low-frequency components executed by the positioning system and results in a command that is within the addressable field of the galvanometers. The stage 14 includes the stage controller 40 as well as X axis servo 42 and Y axis servo 44, X motor 46 and Y axis motor 48 and an XY stage assembly 50. The scan head 16 includes the X axis scan head servo 52 and Y axis scan head servo 54 as well as X axis power and position feedback system 56 and Y axis power and position feedback system 58.

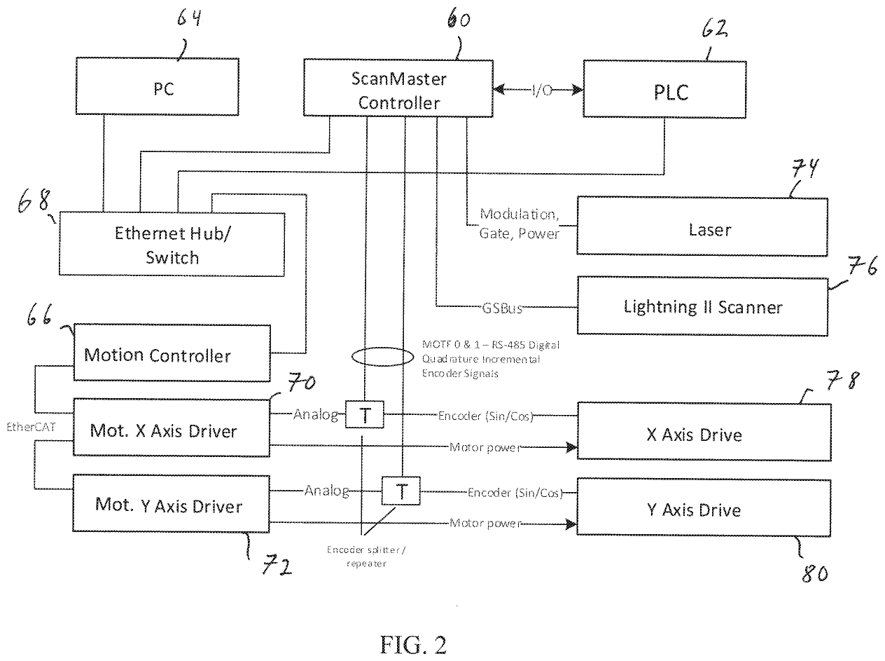

A physical embodiment of the system components is shown in FIG. 2. In the system of FIG. 2 a controller 60, for example, a ScanMaster Controller (SMC) as sold by Cambridge Technology, a Novanta Corporation company of Bedford, Mass. is used to coordinate the marking operation of the system. It is connected to a supervisory programmable logic controller (PLC) 62, a job-preparation PC 64, and motion controller 66, as for example, may be provided by ACS Motion Control, Inc. of Edina, Minn. using Ethernet and TCP/IP communications (e.g., via an Ethernet hub or switch 68) employing various higher-level protocols to pass information.

The controller 60, in parallel, taps into the encoder data that is used by the motion controller 66 thus having direct observation of the position controls of the positioning system that is under control of the motion system. In particular, the motion controller 60 also communicates directly with the PLC 62 via, for example, standard input/output protocols. The motion controller 66 is directly coupled (e.g., via EtherCAT) to the motion X axis driver 70 and in turn to the motion Y axis driver 72, both of which are coupled to the controller 60 as well as the respective X axis drive 7 and Y axis drive 80. The controller 60 also provides controls (e.g., modulation, gate and power) to the laser 74, as well as controls (e.g., GSB μs) to the scanner 76. This direct observation eliminates XY stage controller dependency including potential anomalies such as delays and other unknown effects if the encoder data were to first go to the motion controller and then be echoed back.

During job data processing, the SMC (30) delivers positional updates to the motion controller 66 at a relatively low update rate that can be programed in a range between 100 Hz and 1 KHz. The SMC does not rely on determining whether or not the previous position is reached, only that the motion controller pass the position command forward to the positioning system axis servos as discrete points, or as a series to profiled move data points at its own update rate. The embodiments disclosed herein are provided as examples only of the present invention, and other systems may include, for example, use other motion controllers and servo drivers, particularly if standard Ethernet based TCP/IP communications to the controller is available.

Concurrent with the release of the positioning system controller position updates, the SMC calculates position set points for the galvanometers at a much higher rate (100 KHz). These position updates represent the ideal job data position, position feed-forward bias to eliminate galvanometer tracking delay induced position errors, and global coordinate system adjustments based on the actual position of the positioning system. The coordinated motion control by the SMC continues until the end of the marking job at which time normal positioning system control by the PLC can take place. Note that no special control mode permissions are required—standard published interfaces are exercised in this process.

Although the design of a marking/laser process system of FIG. 2 uses standard software tools such as Cambridge Technology's ScanMaster Designer as sold by Cambridge Technology, a Novanta Corporation company of Bedford, Mass., overall synchronization of motion of the positioning system and scanning systems may require additional configuration information. For example, certain empirically derived properties need to be specified as follows.

The measurement of the location of the positioning system by encoders is done to an accuracy limited by the specific encoders in use (the positioning system encoder resolution). This resolution must be defined in units of mm/encoder-count. To achieve +/−5 μm system accuracy, a typical approach is to use measurement methods that are 10× the requirement, thus the minimum encoder resolution should be at least 0.5 micron per count. Higher resolution will lead to higher precision, however a limit will be reached where the rate that the encoder can produce quadrature pulses, which is a function of positioning system velocity, will be exceeded. A second limit to be considered when choosing the encoder resolution is the ability for the scanner controller to decode the quadrature data at or below certain signaling rates, typically 2.5 MHz.

Another property relates to positioning system tracking delay. This is an empirical measurement which may be made by sending a series of move commands and synchronously sampling the positioning system encoders. The manufacturer of the positioning system controller may provide software to measure this property, however using SyncMaster supporting software facilitates this measurement as it can both drive the positioning system and measure its position.

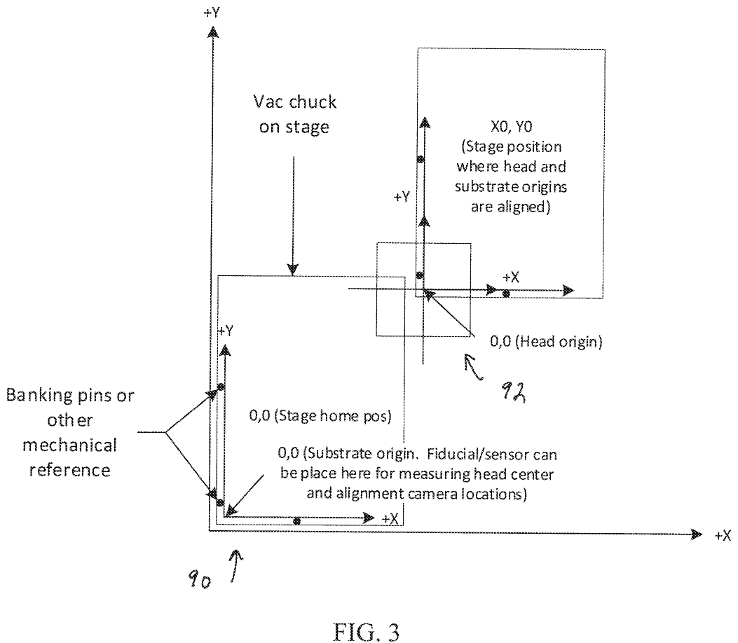

FIG. 3 shows, for example, a possible way to describe the system coordinates in a coordinate linkage system. The key property here is X₀, Y₀, which is the offset from the positioning system home position; if commanded to move there, the system would bring the positioning system to a location such that the workpiece origin is directly beneath the origin of the scan head. FIG. 3 shows a corner-referenced system 90 assuming a substrate could be mechanically placed on the system in a repeatable fashion, for example using banking pins. FIG. 3 shows at 92 a head origin reference system. Again, this is only one embodiment as the material and job coordinate system, for example, could be center referenced as well.

In systems equipped with Lightning II scanners (as sold by sold by Cambridge Technology, a Novanta Corporation company of Bedford, Mass.), measuring the galvanometer tracking delay is done using the Lightning II supporting software, TuneMaster II. A constant velocity stimulus is sent to the scanner using a tool such as ScanMaster Designer, and the tracking delay can be directly determined using the V-Scope feature of TuneMaster II, again, all of which are provided by Cambridge Technology, a Novanta Corporation company of Bedford, Mass.

A further property relates to positioning system encoder calibration data. Advanced motion controllers often have the ability to linearize the encoder sensor using laser interferometer measurement tools to calibrate the motion of the positioning system. The positioning system controller uses the calibration data to alter the axis trajectory in such a way as to minimize the displacement errors that would otherwise be present due to the encoder non-linearity. The scanner controller uses the same calibration data to linearize the encoders in a similar way as the positioning system controller. This is necessary because the scan controller accesses the raw encoder data in parallel with the positioning system controller and does not have access to the calibrated encoder information.

In accordance with various embodiments, the invention provides the use of predictive positioning of the laser steering system based on velocity and acceleration measurement of the moving entity to overcome scanning system tracking delay induced marking errors. The use of such systems enables a flexible system architecture where the positioning system controller can be selected to meet the needs of the integrator. The galvanometer scanning controller constantly tracks the motion of the positioning system independent of the positioning system controller and applies predictive algorithms to minimize the scanner tracking delay induced positional errors. Because of this non-intrusive observational technique, there is no need to tightly couple the time-bases of the Galvanometer Scanning head and positioning system controller. This simplifies the integration process and minimizes the amount of information required to achieve a functioning system.

Those skilled in the art will appreciate that numerous modifications and variations may be made to the above disclosed embodiments without departing from the spirit and scope of the present invention.

What is claimed is:

1. A laser processing system providing on-the-fly laser processing of a workpiece, said laser processing system comprising:
a positioning system configured to support the workpiece;
a positioning system controller configured to control movement of the workpiece on the positioning system;
a scanner system configured to scan a laser beam over the workpiece; and
a scanner controller configured to operate the scanner system and the positioning system controller, said scanner controller receiving vector input data for use in feed-forward position compensation.

2. The laser processing system as claimed in claim 1, wherein the vector input data is, in part, low pass filtered and provided at a reduced data rate

3. The laser processing system as claimed in claim 2, wherein said scanner controller operates the scanner system at a positioning system delay compensated high data rate where scanner positioning is compensated by observation of the positioning system location and speed.

4. The laser processing system as claimed in claim 1, wherein the vector input data is provided along two different paths to provide the reduced data rate input to the positioning system controller and to provide the positioning system delay compensated high data rate input to the scanner controller.

5. The laser processing system as claimed in claim 1, wherein the system calculates a velocity and acceleration of the workpiece by integrating observed positional change over time.

6. The laser processing system as claimed in claim 5, wherein the system predicts future positions of the workpiece using the calculated velocity and acceleration of the workpiece.

7. The laser processing system as claimed in claim 1, wherein a higher bandwidth of the scanner system enables the positioning of galvanometer mirrors to be on a predicted path of the workpiece regardless of changes in velocity or position of the workpiece.

8. The laser processing system as claimed in claim 1, wherein upon job start, low-pass filtered reduced data rate input is provided to the positioning system controller at a rate that is not required to be synchronous with a positioning system delay compensated high data rate input to the scanner controller.

9. A laser processing system providing on-the-fly laser processing of a workpiece, said laser processing system comprising:
a positioning system configured to support the workpiece;
a positioning system controller configured to control movement of the workpiece on the positioning system;
a scanner system configured to scan a laser beam over the workpiece; and
a scanner controller configured to operate the scanner system and the positioning system controller, said scanner controller determining an anticipated vector of the positioning system for use in feed-forward position compensation.

10. The laser processing system as claimed in claim 9, wherein the scanner controller operates the positioning system controller responsive to vector input data that is, in part, time-domain expanded and provided at a reduced data rate, said scanner controller operating the scanner system at a positioning system delay compensated high data rate.

11. The laser processing system as claimed in claim 10, wherein the reduced data rate and the stage delay compensated high data rate are synchronized.

12. The laser processing system as claimed in claim 10, wherein the vector input data is further low pass filtered to provide the reduced data rate.

13. The laser processing system as claimed in claim 10, wherein the vector input data is provided along two different paths to provide the reduced data rate input to the positioning system controller and to provide the positioning system delay compensated high data rate input to the scanner controller.

14. The laser processing system as claimed in claim 9, wherein the system calculates a velocity and acceleration of the workpiece by integrating positional change over time.

15. The laser processing system as claimed in claim 14, wherein the system predicts future positions of the workpiece.

16. The laser processing system as claimed in claim 9, wherein a higher bandwidth of the scanner system enables the positioning of galvanometer mirrors to be on a predicted path of the workpiece regardless of changes in velocity or position of the workpiece.

17. The laser processing system as claimed in claim 9, wherein upon job start, low-pass filtered reduced data rate input is provided to the positioning system controller at a rate that is not necessarily synchronous with the positioning system delay compensated high data rate input to the scanner controller.

18. A method of providing on-the-fly laser processing of a workpiece, said method comprising:
providing a positioning system configured to support the workpiece;
providing a positioning system controller configured to control movement of the workpiece on the positioning system;
providing a scanner system configured to scan a laser beam over the workpiece;
providing a scanner controller configured to operate the scanner system and the positioning system controller;
operating the positioning system controller responsive to vector input data; and
operating the scanner system at a positioning system delay compensated high data rate.

19. The method as claimed in claim 18, wherein the vector input data is, in part, low pass filtered and provided at a reduced data rate.

20. The method as claimed in claim 18, wherein scanner positioning is compensated by observation of the positioning system location and speed.
